(19) United States
(12) Patent Application Publication
(10) Pub. No.: US 2024/0221236 A1
(43) Pub. Date: Jul. 4, 2024

(54) PROVISION OF INDICATORS CONVEYING VISUALLY DISCERNABLE SENTIMENTS IN A PARTICIPANT LIST

(71) Applicant: Avaya Management L.P., Morristown, NJ (US)

(72) Inventors: Jonathan Byron Raflowski, Federal Way, WA (US); Paul Roller Michaelis, Louisville, CO (US)

(21) Appl. No.: 18/398,697

(22) Filed: Dec. 28, 2023

Related U.S. Application Data
(60) Provisional application No. 63/435,871, filed on Dec. 29, 2022.

(51) Int. Cl. G06T 11/00; G06V 40/16; G06V 40/20

(52) U.S. Cl. CPC G06T 11/00; G06V 40/176; G06V 40/20

(57) ABSTRACT

The technology disclosed herein enables a participant list to display indicators conveying visually discernable sentiments of participants identified therein. In a particular embodiment, during a real-time communication session between endpoints of two or more participants, a method includes receiving an image captured of a participant of the participants by a first endpoint of the endpoints, determining a current sentiment of the first participant from the image, and selecting an indicator representing the current sentiment. The method also includes transmitting the indicator to a second endpoint of the endpoints and displaying the indicator with an identifier of the first participant in a participant list for the real-time communication session.

### RELATED APPLICATIONS

This application is related to and claims priority to U.S. Provisional Patent Application 63/435,871, titled “TELECONFERENCE ADJUNCT UTILIZING EMOJIS TO INDICATE EACH PARTICIPANT'S VISUALLY DISCERNIBLE SENTIMENTS,” filed Dec. 29, 2022, and which is hereby incorporated by reference in its entirety.

### BACKGROUND

An important benefit of in-person group meetings is the person who is speaking receives immediate visual feedback—notably via the gestures and facial expressions of the listeners—that can allow the speaker to do real-time assessments of how the speech is being received. Based on those assessments, the speaker can make adjustments or clarifications while the speaker still has the floor. For example, the speaker may determine which listeners are following what's being said and which are confused, which listeners agree/disagree with what is being said, which listeners have questions, and so on. In-person listeners may also look at other listeners to assess their reaction to what is being said.

Products that provide real-time video communications between participants should, in theory, provide a similar benefit to those participants. In practice, the products fall short. If the presenter is sharing his or her screen, e.g., showing a slide deck or sharing a document, the images of the other participants' video transmissions tend to be so small that they are useless for conveying sentiment. Video also uses a significant amount of bandwidth if everyone is transmitting live videos of themselves. Likewise, many people disable their video feed because they do not like others seeing live videos of themselves.

### SUMMARY

The technology disclosed herein enables a participant list to display indicators conveying visually discernable sentiments of participants identified therein. In a particular embodiment, during a real-time communication session between endpoints of two or more participants, a method includes receiving an image captured of a participant of the participants by a first endpoint of the endpoints, determining a current sentiment of the first participant from the image, and selecting an indicator representing the current sentiment. The method also includes transmitting the indicator to a second endpoint of the endpoints and displaying the indicator with an identifier of the first participant in a participant list for the real-time communication session.

In other examples, an apparatus performs the above-recited methods and computer readable storage media directs a processing system to perform the above-recited methods.

### BRIEF DESCRIPTION OF THE DRAWINGS

FIG. 1 illustrates an implementation for displaying indicators in a participant list that convey visually discernable sentiments of the participants identified therein.

FIG. 2 illustrates an operation to display indicators in a participant list that convey visually discernable sentiments of the participants identified therein.

FIG. 3 illustrates an implementation for displaying indicators in a participant list that convey visually discernable sentiments of the participants identified therein.

FIG. 4 illustrates an operational scenario for displaying indicators in a participant list that convey visually discernable sentiments of the participants identified therein.

FIG. 5 illustrates an operational scenario for displaying indicators in a participant list that convey visually discernable sentiments of the participants identified therein.

FIG. 6 illustrates a participant list displaying indicators in a participant list that convey visually discernable sentiments of the participants identified therein.

FIG. 7 illustrates a participant list displaying indicators in a participant list that convey visually discernable sentiments of the participants identified therein.

FIG. 8 illustrates a computing system for displaying indicators in a participant list that convey visually discernable sentiments of the participants identified therein.

### DETAILED DESCRIPTION

Videoconferences have revolutionized the way people communicate, providing a virtual platform that goes beyond mere audio exchanges. As mentioned above, one of the key advantages is the ability to see participants' reactions and emotions in real-time. Unlike traditional conference calls, video conferences leverage cameras at endpoints to capture facial expressions, body language, and gestures. This visual element adds a layer of depth to communication, allowing participants to pick up on non-verbal cues that play a crucial role in understanding the nuances of a conversation.

The use of video in conferences facilitates a more authentic and engaging interaction. Seeing a colleague's smile, nod of agreement, or furrowed brow adds a human touch to the conversation, fostering a sense of connection that can be lacking in purely text-based or audio communication. This visual dimension is particularly valuable in professional settings, where understanding the emotional context of discussions is vital for effective collaboration and decision-making. Thus, during audio calls/conferences are videoconferences where video is turned off, participants may be missing valuable unspoken insight into their fellow participants behavior.

In the user interface of most videoconferencing platforms, a participant list is a feature that enhances the overall experience. Typically displayed on the side or bottom of a window displayed by the videoconferencing client application, the participant list provides a visual roster of everyone present in the meeting. Each participant is usually represented by an identifier (e.g., the participant's name or username) and, often, a thumbnail image or video feed of their camera. This feature serves multiple purposes—it helps users identify who is actively participating, allows for quick reference to names and faces, and often includes indicators such as mute icons or status symbols to convey whether a participant is speaking, muted, or has their camera turned off.

The participant list is not merely a static display; it actively reflects the dynamic nature of the meeting. As participants join or leave the conference, the list is updated in real-time, providing users with an instant overview of the current attendance. This visual representation fosters a sense of presence and inclusivity, enabling participants to stay aware of the group dynamics and contributing to the overall effectiveness of the video conference as a collaborative tool. The participant lists described below further enhance the benefits of a participant list by providing indicators about a participant's current sentiment with the participant's identifier in the list.

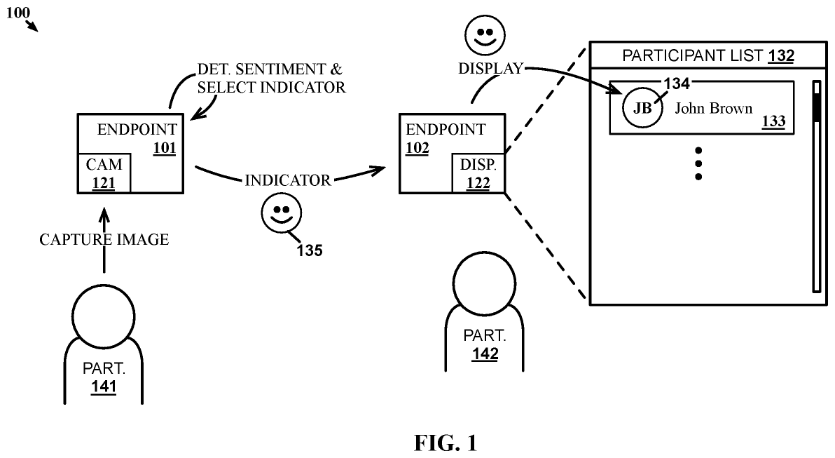

FIG. 1 illustrates implementation 100 for displaying indicators in a participant list that convey visually discernable sentiments of the participants identified therein. Implementation 100 includes endpoint 101 and endpoint 102. Although not shown, endpoint 101 and endpoint 102 communicate over one or more wired and/or wireless communication links. The communication links may be direct links or may include intervening systems, networks, and/or devices. Likewise, endpoint 101 and endpoint 102 may communicate through a communication session system (e.g., conferencing server) that facilitates communication sessions between endpoints. Endpoint 101 and endpoint 102 may each respectively be a telephone, tablet computer, laptop computer, desktop computer, conference room system, or some other type of computing device capable of establishing real-time user communication sessions between endpoint 101 and endpoint 102. In some examples, endpoint 101 and endpoint 102 may execute a client application thereon that facilitates communication sessions between endpoint 101 and endpoint 102.

In this example, endpoint 101 includes camera 121 which captures images of participant 141. The images may be still images or video images. The images may be transmitted to endpoint 102 if the communication session between endpoint 101 and endpoint 102 supports transmission of images (e.g., the communication session may be a videoconference or video call). The images are used throughout the communication session to determine participant 141's current sentiment, select indicator 135 of that current sentiment, and send indicator 135 to endpoint 102. Endpoint 102 displays indicator 135 with participant identifier 133 of participant 141 in participant list 132. Participant list 132 is displayed by display 122 of endpoint 102 along with other user interface elements (e.g., those of a client application, an operating system, or other applications executing on endpoint 102). Display 122 may be a Liquid Crystal Display (LCD), a Light-Emitting Diode (LED) display, Organic Light-Emitting Diode (OLED) display, a Cathode Ray Tube (CRT) display, or some other type of display capable of displaying a participant list. Display 122 may be incorporated into a main housing of endpoint 102 or may be connected to endpoint 102 as an external peripheral. Camera 121 may similarly be incorporated into a main housing of endpoint 101 or may be connected to endpoint 101 as an external peripheral.

While not shown, endpoint 101 may also include a display to show a participant list with an identifier of participant 142 operating endpoint 102. Endpoint 102 may likewise include a camera enabling endpoint 102 to determine the current sentiment of participant 142 that will be displayed in the participant list at endpoint 101 (e.g., reversing the process shown in implementation 100 and explained in operation 200 below). Also, in this example, participant list 132 only shows one participant, participant 141 identified as John Brown in participant identifier 133. In other examples, participant 142 may also be identified in participant list 132. Likewise, if the communication session is between more than two participants, those other participants may be identified in participant list 132 as well.

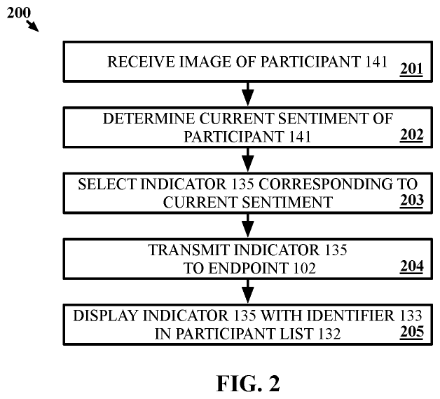

FIG. 2 illustrates operation 200 to display indicators in a participant list that convey visually discernable sentiments of the participants identified therein. In operation 200, a real-time communication session is established between endpoint 101 and endpoint 102. The real-time communication session may be voice only, may include video, or may be some other type of communication session for exchanging user communications in real time and displays a participant list. While the communication session is between two endpoints in this example, other examples may include any number of endpoints. Similarly, endpoint 101 and endpoint 102 have respective users, participant 141 and participant 142, thereat but other examples may include multiple participants at one or more of the endpoints.

During the real-time communication session, endpoint 101 receives an image captured of participant 141 (step 201). Endpoint 101 receives the image from camera 121. The image may be a still image or may be a video image. In some examples, the image may be transmitted over the communication session. For instance, if the communication session is a videoconference, endpoint 101 may use the same video image transmitted over the videoconference to endpoint 102 for the sentiment determination purposes described below. Even if participant 141 has elected to not transmit video captured of themselves, endpoint 101 may still capture for sentiment determination.

Endpoint 101 determines a current sentiment of participant 141 from the image (step 202). The current sentiment may indicate any information that a participant viewing the image of participant 141 may also glean about participant 141 from the image. The sentiment may indicate participant 141's emotional state (e.g., whether participant 141 is happy, sad, angry, excited, etc.), understanding of or reactions to the subject matter (e.g., confusion, agreement, disagreement, questioning, etc.), or some other unspoken information about participant 141's mental state as indicated by the image. Facial recognition, or other type of image processing, may be employed by endpoint 101 to determine the sentiment of participant 141 from the image. In some examples, the processing algorithm may be a machine learning algorithm trained on images of participants with a known sentiment to identify sentiments in subsequently provided images.

After determining the current sentiment, endpoint 101 selects indicator 135 representing the current sentiment (step 203). Indicator 135 may be selected from indicators in a data structure of indicators with corresponding sentiments. Indicator 135 is a graphic indicating a smiling face, which may correspond to endpoint 101 determining that participant 141's current sentiment is happy. Other graphics may be used to indicate other sentiments (e.g., a frown faced graphic indicating sadness). The indicators may be proprietary graphics or may be standardized graphics, such as emojis. The indicators may be animated as well to further convey sentiment or draw attention to a particular sentiment when displayed. For example, if a participant's sentiment is excited, the indicator may be an animation of fireworks. Indicator 135 may also take forms other than graphical in some examples. For example, indicator 135 may use characters (e.g., to spell out works or emoticons).

Endpoint 101 transmits indicator 135 to endpoint 102 (step 204). Indicator 135 may be transmitted via a channel of the communication session dedicated to transmission of indicators, may be transmitted in control signaling for the communication session (e.g., a Session Initiation Protocol (SIP) control message), or by some other mechanism. In examples such as this one, indicator 135 may be transmitted as an image file containing the graphic or as a code corresponding to the graphic. In the latter situation, endpoint 102 is able to lookup the code to retrieve a local copy of the graphic for indicator 135. Emojis are a specific example where standardized codes are used to transmit graphics between endpoints. Emojis are based on the Unicode Consortium's coding system, which assigns a unique code point to each character across various languages and symbols. Introduced to ensure consistency and interoperability across different platforms and devices, Unicode assigns a specific numerical code to each emoji. This system allows emojis to be universally recognized and displayed consistently across devices, regardless of the operating system. Emojis' character codes ensure that when someone sends a particular emoji, it is interpreted accurately by the recipient's device, maintaining the intended expression, and fostering a shared visual language in the vast landscape of digital communication. Thus, when endpoint 101 sends a code corresponding to a selected emoji for indicator 135, endpoint 101 can rely on endpoint 102 to identify the correct emoji on receipt.

Upon receiving indicator 135, endpoint 102 displays indicator 135 with participant identifier 133 of participant 141 in participant list 132 (step 205). Endpoint 102 may recognize with which participant indicator 135 is associated based on indicator 135 being received from endpoint 101, a message including indicator 135 may indicate participant 141 as the associated participant, or endpoint 102 may determine indicator 135 is associated with participant 141 in some other manner. In this example, image 134 is already displayed with participant identifier 133, although not all types of participant lists will include an image like image 134 with participant identifier 133. Image 134 is a generic image indicating John Brown's (i.e., participant 141) initials but could be other types of images. For instance, participant 141 may select a default image that they want displayed next to their name during communication sessions. Endpoint 102 replaces image 134 in participant list 132 with indicator 135 in this example. Endpoint 102 may position indicator 135 elsewhere so as to not obscure image 134 in other examples. No matter the location indicator 135, endpoint 102 positions the indicator such that participant 142 can easily recognize that indicator 135 is associated with participant identifier 133 in participant list 132.

Advantageously, participant 142 can easily see participant 141's sentiment within participant list 132 even if participant 142 cannot actually see an image captured of participant 142. Even during videoconferences where participant 141 is sharing their video, participant 142 may not be able to see the video of participant 141 well enough to determine sentiment. For example, when a lot of participants are on a session, the video of many participants may be reduced to a thumbnail or not shown at all. The thumbnails may be too small to for participant 142 to determine sentiment therefrom even though they can technically be seen by participant 142. Likewise, with many participants not able to be seen, it may be hard for participant 142 to determine an aggregate sentiment across the participants. In some examples, such as participant list 700 described below, endpoint 102 may aggregate the received sentiments to give participant 142 a better view of the sentiments of participants as a whole during the session.

Displaying indicator 135 may also benefit visually impaired participants. Screen reader applications play a pivotal role in enhancing the accessibility of digital content for visually impaired users. These applications, designed to convert on-screen text into synthesized speech or Braille output, empower individuals with visual disabilities to navigate and interact with a wide array of digital platforms. The primary benefit lies in providing equal access to information and technology, enabling visually impaired users to independently browse websites, read documents, and use various software applications. Screen readers contribute to inclusivity by offering a seamless and personalized experience, allowing users to customize settings based on their preferences and needs. Moreover, these applications extend beyond text, providing spoken descriptions of images and other multimedia elements. Thus, a screen reader application executing on endpoint 102 may audibly describe indicator 135, or convert that description to braille, either automatically or upon instruction from participant 142, so that endpoint 102 is aware of the sentiment conveyed by indicator 135 without having to see it. In some examples, indicator 135 may include underlying text that the screen reader will read to describe indicator 135 even though the text may not actually be displayed. In one example, some graphics will display a small popup of text explaining the graphic when a cursor hovers over the graphic. A visually impaired user may perform the equivalent of hovering over participant identifier 133 to trigger the screen reader to read the text.

Operation 200 may repeat throughout the communication session to update participant 142 regarding participant 141's sentiment at the current time. Endpoint 101 may be configured to periodically determine participant 141's current sentiment or may be configured to continually monitor images captured of participant 141 to determine whether participant 141's sentiment changes. Indicator 135 may then be updated when participant 141's sentiment changes.

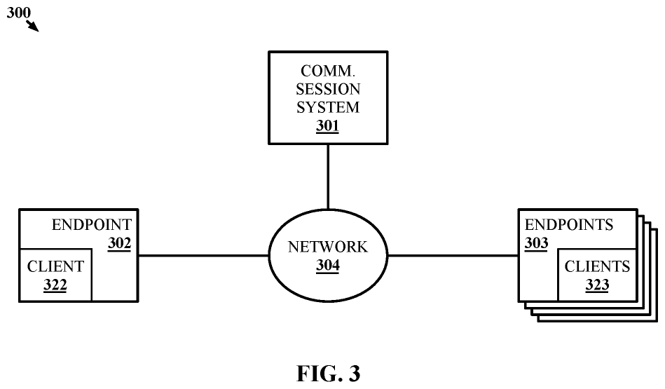

FIG. 3 illustrates implementation 300 for displaying indicators in a participant list that convey visually discernable sentiments of the participants identified therein. Implementation 300 includes communication session system 301, endpoint 302, endpoints 303, and communication network 304. Communication network 304 includes one or more local area networks and/or wide area computing networks, such as the Internet, over which elements 301-303 communicate. Communication session system 301 is shown as a single device but may be distributed across multiple devices.

Communication session system 301 acts as a central facilitator enabling seamless communication between endpoints 302-303 during virtual meetings. Its primary function is to manage and coordinate the exchange of audio, video, and data streams between endpoints 302-303. When a videoconference is initiated, the server establishes connections with each endpoint, managing the flow of information to ensure real-time synchronization. Communication session system 301 plays a crucial role in handling tasks such as video encoding and decoding, bandwidth management, and echo cancellation, optimizing the quality of the communication experience. Additionally, communication session system 301 may facilitate features like screen sharing, chat, and file sharing, enhancing the collaborative aspects of the session. Security measures, such as encryption and authentication, are also often implemented by communication session system 301 to safeguard the confidentiality of the communication. In this example, communication session system 301 further facilitates sentiment determinations for participants operating endpoints 302-303 and selection of indicators corresponding to those sentiments. Although, other examples included communication session system 301 may still rely on endpoints to determine sentiments and corresponding indicators for their respective participants.

In this example, endpoint 302 executes client application 322 and endpoints 303 execute client applications 323 to communicate with communication session system 301. Client applications 322-323 further provide user interfaces through which participants participate in the communication sessions established via communication session system 301. In this example, the user interfaces include participant lists displaying identifiers of the participants on the communication session. The participant lists will also include indicators of sentiment, as determined by communication session system 301 per the example scenarios below.

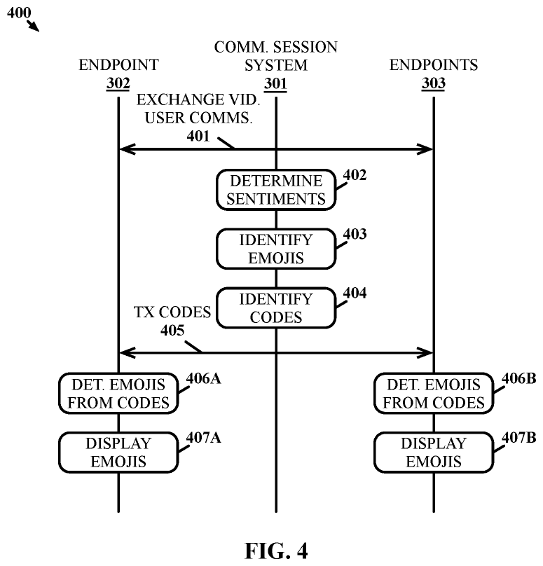

FIG. 4 illustrates operational scenario 400 for displaying indicators in a participant list that convey visually discernable sentiments of the participants identified therein. In operational scenario 400, user communications are exchanged at step 401 between endpoints 302-303 over a communication session established therebetween. The user communications in this example pass through communication session system 301 facilitating the communication session. The communication session is a videoconference in this example and the user communications include video captured of the participants at each of endpoints 302-303. The user communications may further include voice, text, media, or any other type of real-time communications participants may want to exchange over the communication session.

Communication session system 301 determines sentiments of the participants captured in the received video at step 402. The sentiments may be determined using video image processing to identify facial expressions (e.g., smiles, frowns, brow furrows, etc.), gestures (e.g., hand movements, head movements, etc.), or some other type of visual cue indicating the participants' current sentiments. Communication session system 301 may determine the sentiments of all participants or a subset of the participants, such as those participants providing video or who have opted in to having their sentiment determined. In some examples, even if a participant has their outgoing video feed muted so that other participants on the communication session cannot see them, the participant's endpoint may still transmit video to communication session system 301 for sentiment determination. Communication session system 301 may not forward the received video over the communication session while the participant's video feed remains muted. In other examples, communication session system 301 may delegate sentiment determination to the participant's endpoint so that endpoint need not transmit video at all.

For each of the participants for whom a sentiment was identified, communication session system 301 identifies a corresponding emoji to that sentiment at step 403. The emoji library includes dozens of emojis that can be used to express even nuanced user sentiment. For example, there are multiple types of smiling emojis, smirks, a grimacing face, a thinking face, a disappointed face, and an angry face, among many others. Communication session system 301 selects an emoji for each participant that best fits with the determined sentiment. Since emojis correspond to standardized character codes, communication session system 301 identifies the character codes for the selected emojis at step 404. Communication session system 301 transmits the character codes to endpoints 302-303 at step 405 rather than the emoji graphics. The codes may be transmitted over a control channel for the communication session, may be transmitted over a channel intended for emoji transmission, or may be transmitted in some other manner recognized by endpoints 302-303 as intended for presentation in participant lists (e.g., rather than for display in a chat stream of the communication session).

In response to receiving the codes, endpoints 302-303 determine the emojis corresponding to the codes at step 406. Endpoints 302-303 display the determined emojis at step 407 in the respective participant lists at endpoints 302-303. All of endpoints 302-303 include emojis in their participant lists in this example. However, in other examples, fewer than all of endpoints 302-303 may display the emojis. For instance, a participant at endpoint 302 may be a presenter presenting slides over the communication session. The presenter may be interested in the sentiments of the participants at endpoints 303 so the presenter can adjust their presentation on the fly based on the sentiments. Communication session system 301 may, therefore, facilitate the display of emojis in the presenter's participant list at endpoint 302 but does not display emojis in the participant lists of endpoints 303.

It should be understood that emojis may appear different across different endpoint devices due to the implementation of different operating systems and software designs. Emojis are standardized by the Unicode Consortium, but the actual visual representation of emojis is left to the discretion of individual platforms. Operating systems such as iOS®, Android®, Windows®, and others have their own design guidelines and artistic interpretations for emojis, resulting in variations in appearance. Consequently, users may notice differences in the way emojis look when exchanged between devices or platforms. Despite these visual distinctions, the underlying Unicode coding ensures that the intended meaning and representation of the emoji (i.e., the sentiment determined herein) remain consistent across diverse digital environments.

Like with operation 200, communication session system 301 may continue to update the sentiments and emojis throughout the communication session. Participants are, therefore, kept up to date regarding the sentiments of their fellow participants as the session progresses.

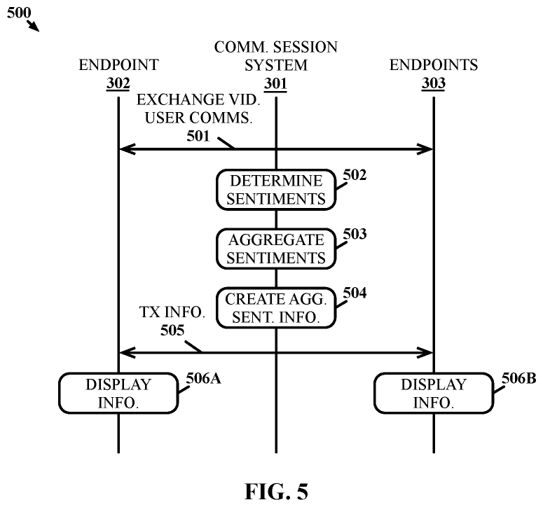

FIG. 5 illustrates operational scenario 500 for displaying indicators in a participant list that convey visually discernable sentiments of the participants identified therein. Operational scenario 500 begins similarly to operational scenario 400 with endpoints 302-303 exchanging video user communications at step 501 over a communication session facilitated by communication session system 301. Sentiments of the participants operating endpoints 302-303 are likewise determined at step 502. Operational scenario 500 may occur in conjunction with operational scenario 400. Therefore, steps 501 and 502 may be the same as steps 401 and 402.

Communication session system 301 aggregates the sentiments in step 503 to determine a broader indication of the sentiment across the participants. Aggregating the sentiments may include counting the number of participants having the same sentiment (e.g., 4 participants are excited, 2 are not engaged, and 3 are questioning). Aggregating the sentiments may include determining a broader category for groups of sentiments, especially in situations where the number of different sentiments is large. For instance, the aggregated sentiments may indicate a number of participants having a positive sentiment (e.g., happy, excited, understanding, etc.) and a number of participants having a negative sentiment (e.g., sad, frustrated, angry, confused, etc.). Communication session system 301 may generate metrics from the aggregated sentiment. For example, instead of simply stating a number of participants having a particular sentiment, communication session system 301 may calculate a percentage of participants having the sentiment.

After aggregating the sentiments, communication session system 301 creates aggregated sentiment information at step 504 to inform endpoints 302-303 about what they should present to convey the aggregated sentiment. The aggregated sentiment information may include one or more indicators like the individual sentiments discussed above. For example, if the participants are predominantly happy or positive at the current time, then a happy-face image or emoji may be selected for inclusion in the aggregated sentiment information. Communication session system 301 transmits the aggregated sentiment information at step 505 to endpoints 302-303. Endpoints 302-303 display the aggregated sentiment information at step 506 in their respective participant lists. Since the aggregated sentiment information is not associated with any one particular participant, endpoints 302-303 may create space in their participant lists for the aggregated sentiment information. The space may be created at the top of the participant list for greater visibility, but other locations can be used. In some examples, the aggregated sentiment information may trigger endpoints 302-303 to create a dummy participant identifier in their participant list to make room for the aggregated sentiment information to be displayed therein.

As was the case in operational scenario 400, while operational scenario 500 distributes aggregated sentiment information for display to all of endpoints 302-303, other examples may only distribute the aggregated sentiment information to certain endpoints (e.g., to a presenter's endpoint to give the presenter an idea about how participants are reacting to the presentation).

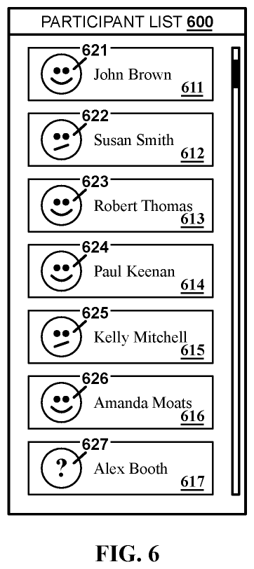

FIG. 6 illustrates participant list 600 displaying indicators in a participant list that convey visually discernable sentiments of the participants identified therein. Participant list 600 is an example participant list that may be displayed by one of endpoints 302-303 in operational scenario 400. Participant list 600 is merely a generic example of a participant list to show how indicators of user sentiment may be displayed with participant identifiers. Other participant list examples may be formatted differently for display or may include other information (e.g., active speaker status information).

In participant list 600, seven participants are identified by participant identifiers 611-617. The communication session may include additional participants if a participant scrolls down participant list 600. Participant identifiers 611-617 may be ordered in participant list 600 based on most recent speaking activity, based on seniority relative to other participants, based on an arbitrary ordering, or using some other ordering methodology. Each of participant identifiers 611-617 has one of corresponding indicators 621-627 therewith. Indicators 621-627 are graphics that indicate a sentiment currently being expressed by the corresponding participant. For example, John Brown identified by participant identifier 611 is currently happy with whatever is happening on the communication session, as indicated by indicator 621. In contrast, Susan Smith was not determined to be happy as indicated by indicator 622 in participant identifier 612. Participant identifier 627 includes a question mark, which may indicate that communication session system 301 could not determine a sentiment for Alex Booth (e.g., due to Alex not providing video for analysis or due to communication session system 301 not being able to determine a sentiment from video that was provided). While there are only three different indicators in indicators 621-627, other examples may include any number of different indicators (e.g., sad, frustrated, angry, etc.).

In some examples, participant list 600 may highlight (e.g., create a colored border, animate, make brighter, etc.) a participant identifier or an indicator with that participant identifier to draw the attention of a participant viewing participant list 600 to the sentiment for the identified participant. The highlighting may occur when the sentiment changes in general, when the sentiment changes to a particular sentiment, or for some other reason. The viewing participant may define when they want the highlighting to occur (e.g., may define particular participants, particular sentiments, or other triggers).

In some examples, participant list 600 may also show sentiment indicator for the participant viewing participant list 600 so that the participant knows what sentiment is being shown to the other participants. For example, John Brown may be the participant viewing participant list 600 on his endpoint. Providing indicator 621 in participant list 600 enables John to see what indicator others are seeing in their participant lists. John may choose to adjust his demeanor to change indicator 621. In some examples, John may be train communication session system 301 (or his own endpoint depending on which system is tasked with performing the sentiment analysis). The training may happen during the communication session or at some other time. For example, if John is happy but indicator 621 indicates a different sentiment, John may provide user input as feedback indicating that he is actually happy. The video processing algorithm used to determine sentiment may then adjust its subsequent determinations based on the feedback from John, which should result in more accurate determinations going forward.

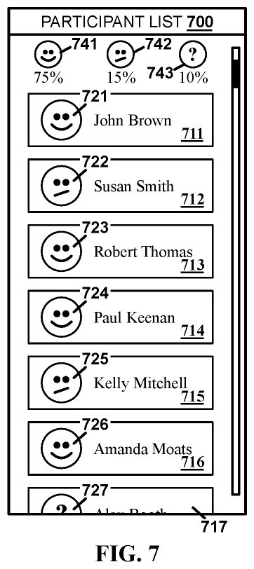

FIG. 7 illustrates participant list 700 displaying indicators in a participant list that convey visually discernable sentiments of the participants identified therein. Participant list 700 is another example participant list that may be displayed by one of endpoints 302-303 in operational scenario 500. In this case, participant list 700 is an example of participant list 600 but augmented with aggregated sentiment information. Participant identifiers 711-717 correspond to participant identifiers 611-617 and indicators 621-627 correspond to indicators 721-727. In other examples, indicators 721-727 may not be included and participant identifiers 711-717 may include default images instead.

Participant list 700 includes room at the top for indicators 741-743 of aggregated sentiment for participants on the communication session. Relative to participant list 600, the bottom most participant identifier 717 for Alex Booth is hidden. Scrolling participant list 700 may result in participant identifier 717 returning to full view. In this example, indicator 741 shows that 75% of the participants are currently happy while indicator 742 shows that 15% of the participants were not determined to be happy. Indicator 743 indicates that sentiment for the remaining 10% of participants could not be determined. Other manners of indicating aggregated sentiment information may be used in other examples.

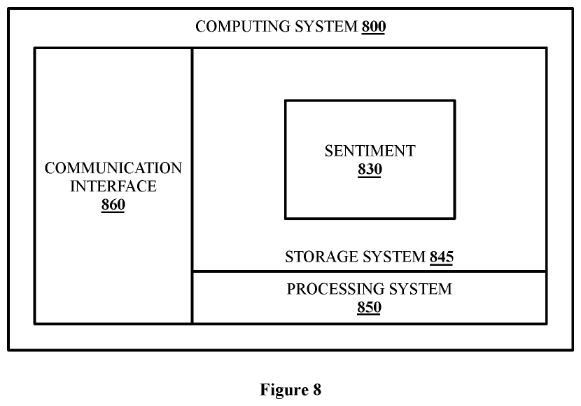

FIG. 8 illustrates computing system 800 for displaying indicators in a participant list that convey visually discernable sentiments of the participants identified therein. Computing system 800 is representative of any computing system or systems with which the various operational architectures, processes, scenarios, and sequences disclosed herein can be implemented. Computing system 800 is an example architecture for endpoints 101-102 and 302-303 and communication session system 301, although other examples may exist. Computing system 800 includes storage system 845, processing system 850, and communication interface 860. Processing system 850 is operatively linked to communication interface 860 and storage system 845. Communication interface 860 may be communicatively linked to storage system 845 in some implementations. Computing system 800 may further include other components such as a battery and enclosure that are not shown for clarity.

Communication interface 860 comprises components that communicate over communication links, such as network cards, ports, radio frequency (RF), processing circuitry and software, or some other communication devices. Communication interface 860 may be configured to communicate over metallic, wireless, or optical links. Communication interface 860 may be configured to use Time Division Multiplex (TDM), Internet Protocol (IP), Ethernet, optical networking, wireless protocols, communication signaling, or some other communication format—including combinations thereof. Communication interface 860 may be configured to communicate with one or more web servers and other computing systems via one or more networks.

Processing system 850 comprises microprocessor and other circuitry that retrieves and executes operating software from storage system 845. Storage system 845 may include volatile and nonvolatile, removable, and non-removable media implemented in any method or technology for storage of information, such as computer readable instructions, data structures, program modules, or other data. Storage system 845 may be implemented as a single storage device but may also be implemented across multiple storage devices or sub-systems. Storage system 845 may comprise additional elements, such as a controller to read operating software from the storage systems. Examples of storage media include random access memory, read only memory, magnetic disks, optical disks, and flash memory, as well as any combination or variation thereof, or any other type of storage media. In some implementations, the storage media may be a non-transitory storage media. In some instances, at least a portion of the storage media may be transitory. In no interpretations would storage media of storage system 845, or any other computer-readable storage medium herein, be considered a transitory form of signal transmission (often referred to as “signals per se”), such as a propagating electrical or electromagnetic signal or carrier wave.

Processing system 850 is typically mounted on a circuit board that may also hold the storage system. The operating software of storage system 845 comprises computer programs, firmware, or some other form of machine-readable program instructions. The operating software of storage system 845 comprises sentiment module 830. The operating software on storage system 845 may further include an operating system, utilities, drivers, network interfaces, applications, or some other type of software. When read and executed by processing system 850, the operating software on storage system 845 directs computing system 800 to display indicators in a participant list that convey visually discernable sentiments of the participants identified therein as described herein.

In at least one example, computing system 800 is a transmitting system (e.g., endpoint 101 or communication session system 301). During a real-time communication session between endpoints of two or more participants, sentiment module 830 directs processing system 850 to receive capture an image of a participant of the participants, determine a current sentiment of the first participant from the image, select an indicator representing the current sentiment, and transmit the indicator to a second endpoint of the endpoints. The second endpoint displays the indicator with an identifier of the first participant in a participant list for the real-time communication session.

In another example, computing system 800 is a receiving system (e.g., endpoint 102 or endpoints 302-303). During a real-time communication session between endpoints of two or more participants, sentiment module 830 directs processing system 850 to receive an emoji indicating a current sentiment of a first participant of the participants. An endpoint of the first participant captured an image from which the current sentiment was determined. Sentiment module 830 also directs processing system 850 to display the emoji with an identifier of the first participant in a participant list for the real-time communication session.

The included descriptions and figures depict specific implementations to teach those skilled in the art how to make and use the best mode. For teaching inventive principles, some conventional aspects have been simplified or omitted. Those skilled in the art will appreciate variations from these implementations that fall within the scope of the invention. Those skilled in the art will also appreciate that the features described above can be combined in various ways to form multiple implementations. As a result, the invention is not limited to the specific implementations described above, but only by the claims and their equivalents.

What is claimed is:

1. A method for providing indicators in a participant list to convey visually discernable sentiments, the method comprising:
during a real-time communication session between endpoints of two or more participants, receiving an image captured of a participant of the participants by a first endpoint of the endpoints;
determining a current sentiment of the first participant from the image;
selecting an indicator representing the current sentiment;
transmitting the indicator to a second endpoint of the endpoints; and
displaying the indicator with an identifier of the first participant in a participant list for the real-time communication session.

2. The method of claim 1, wherein displaying the indicator comprises:
replacing a default image corresponding to the first participant in the participant list with indicator.

3. The method of claim 2, wherein transmitting the indicator comprises:
determining a character code corresponding to the indicator; and
transmitting the character code.

4. The method of claim 1, wherein selecting the indicator comprises:
identifying the current sentiment in a data structure of sentiments and corresponding indicators to the sentiments;

5. The method of claim 1, comprising:
receiving additional images captured of other participants of the participants by respective endpoints of the other participants;
determining respective current sentiments for the other participants from the additional images;
aggregating the current sentiment and the respective current sentiments into aggregated sentiment information;
transmitting the aggregated sentiment information to the second endpoint; and
displaying the aggregated sentiment information in the participant list.

6. The method of claim 1, comprising:
highlighting the identifier when the current sentiment satisfies a highlighting criterion.

7. The method of claim 6, comprising:
receiving the highlighting criterion from a user at the second endpoint, wherein the highlighting criterion indicates when the user wishes to be alerted to the current sentiment.

8. The method of claim 1, wherein the image is a video image or a still image.

9. The method of claim 1, wherein indicator is an emoji.

10. The method of claim 9, wherein the emoji is animated.

11. A apparatus for or providing indicators in a participant list to convey visually discernable sentiments, the apparatus comprising:
one or more computer readable storage media;
one or more processing systems operatively coupled with the one or more computer readable storage media; and
program instructions stored on the one or more computer readable storage media that, when read and executed by the processing system, direct the apparatus to:
during a real-time communication session between endpoints of two or more participants, capture an image of a first participant of the participants;
determine a current sentiment of the first participant from the image;
select an indicator representing the current sentiment; and
transmit the indicator to a second endpoint of the endpoints, wherein the second endpoint displays the indicator with an identifier of the first participant in a participant list for the real-time communication session.

12. The apparatus of claim 11, wherein to display the indicator, the second endpoint replaces a default image corresponding to the first participant in the participant list with indicator.

13. The apparatus of claim 12, wherein to transmit the indicator, the program instructions direct the processing system to:
determine a character code corresponding to the indicator; and
transmit the character code.

14. The apparatus of claim 11, wherein to select the indicator, the program instructions direct the processing system to:
identifying the current sentiment in a data structure of sentiments and corresponding indicators to the sentiments;

15. The apparatus of claim 11, wherein the second endpoint highlights the identifier when the current sentiment satisfies a highlighting criterion.

16. The apparatus of claim 11, wherein the image is a video image or a still image.

17. The apparatus of claim 11, wherein indicator is an emoji.

18. The apparatus of claim 17, wherein the emoji is animated.

19. A apparatus for or providing indicators in a participant list to convey visually discernable sentiments, the apparatus comprising:
one or more computer readable storage media;
one or more processing systems operatively coupled with the one or more computer readable storage media; and
program instructions stored on the one or more computer readable storage media that, when read and executed by the processing system, direct the apparatus to:
during a real-time communication session between endpoints of two or more participants, receive an emoji indicating a current sentiment of a first participant of the participants, wherein an endpoint of the first participant captured an image from which the current sentiment was determined;
display the emoji with an identifier of the first participant in a participant list for the real-time communication session.

20. The apparatus of claim 11, wherein the program instructions direct the processing system to:
receive aggregated sentiment information, wherein the aggregated sentiment information is created from respective current sentiments of other participants of the participants; and
display the aggregated sentiment information in the participant list.
